(19) United States
(12) Patent Application Publication
(10) Pub. No.: US 2014/0150280 A1
(43) Pub. Date: Jun. 5, 2014

(54) PRODUCTIVITY-BOOSTER INNOVATION IN CARPET OR MAT DRYING MACHINES

(71) Applicants: Ali Kamil GORAL, Bandirma (TR); Hayri DOGRU, Bandirma (TR); Haldun Zeki SEVER, Bandirma (TR)

(72) Inventors: Ali Kamil GORAL, Bandirma (TR); Hayri DOGRU, Bandirma (TR); Haldun Zeki SEVER, Bandirma (TR)

(73) Assignee: GFS Makina San. VE TIC. LTD. STI., Bandirma (TR)

(21) Appl. No.: 13/874,804

(22) Filed: May 1, 2013

(30) Foreign Application Priority Data
Dec. 5, 2012 (TR) 2012/14192

(51) Int. Cl. F26B 13/18

(52) U.S. Cl. CPC F26B 13/183
USPC 34/110

(57) ABSTRACT

Productivity-boosting innovations in drying machines used for drying carpets, mats and the like are provided. The innovations allow the chine to operate more quietly, to be lighter and to be used, in accordance with the intended use, more efficiently and for a longer period of time with less energy consumption by preventing its parts from getting heated. An internal drum which is embedded in the front and back frame by the inner drum shaft and roller and which is moved by the motor is made of composite material. An external drum coats the internal drum externally and allows the machine to work more quietly thanks to its isolation. A fan is provided for decreasing the temperature of the roller of the machine while it is operating.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

REFERENCE TO AN APPENDIX SUBMITTED ON COMPACT DISC

Not applicable.

### BACKGROUND OF THE INVENTION

1. Field of the Invention

The present invention relates to a productivity-booster innovation in drying machines used for drying carpets and mats. The productivity-booster allows the machine to operate more quietly, to be lighter and to be used in accordance with the intended purpose, more efficiently and for a longer period of time, with less energy consumption by preventing its parts from getting heated.

The present invention especially relates to an internal drum which is embedded in the front and back frame thanks to the inner drum shaft and roller and which is made of composite material, the external drum coating the internal drum externally and providing the machine to work more quietly thanks to its isolation, and a fan decreasing the temperature of the roller of the machine while it is operating.

2. Description of Related Art Including Information Disclosed under 37 CFR 1.97 and 37 CFR 1.98.

Currently, carpets and mars are used on the floors of many residential places, such as houses, offices, etc. When they get dirty, these carpets and mats need to be washed in order to be cleaned. The carpets and mats that have been washed are dried by means of drying machines. Said drying machines basically comprise a roller on a frame, a drum embedded in two-sides with the parts such as bearing, etc., an external drum coating said drum, a motor rotated on the frame where said drum is embedded, and accessories such as a strap, pulley and shaft, etc. which make this rotational movement easy.

In the current technique, there are many different embodiments of the drying machines which are basically described above. One of these embodiments is disclosed in the application titled “innovation in the carpet-drying and centrifuge machine” and numbered TR 2005/01530. In the summary of this application, it is said that “The present invention relates to drying the washed carpets”. With the help of the machine according to the invention, the washed carpets, mats, blankets, etc. are dried. The machine according to the invention has been developed to dry the carpets with 90 dryness and 10% wetness in a short period of 8 minutes. It is explained that “the machine according to the invention comprises a body/external drum, an internal drum inside the body/external drum, a cap covering the mouth part of the machine, a motor at the back part of the external drum, a motor pulley connected to this motor shaft, an internal drum pulley to which the movement at this drum is transmitted by means of straps, an inner drum back shaft passing through this drum, and a drum back roller fitted to the bearing on the external drum back flange”.

Another drying machine embodiment in the current technique is disclosed in the application numbered TR 2003/01105 and titled “carpet drying and centrifuge machine”. The summary of this application is as follows: “the machine according to the invention comprises an external drum located on the flame by means of the cushioning, springs, an internal drum inside the external drum, a cap bearing covering the mouth part of the machine, a cap and a roller on the cap bearing, a motor at the back part of the external drum, a motor pulley connected to the shall of this motor, an internal drum pulley, the movement of which on this pulley is transmitted by means of moving straps, an internal drum back shaft passing through this pulley, and internal drum back roller fitted to the bearing (39) on the back flange of the eternal drum”.

Two embodiments described above and the carpet- or mat-drying machines within the state of the art have some shortcomings and disadvantages. One of them is that the internal drum used in the current drying machines is made of stainless steel comprising metal. This situation causes the internal drum, and therefore the related drying machine, to be heavy in terms of mass. In order to rotate the inner drum having a heavy mass, more force is needed, and it gets difficult, When more force is needed to rotate the internal drum, said drying machine is used with much more energy consumption. Moreover, as the internal drum is made of metal-comprising material, the production of said drum becomes difficult and takes a long time. The difficulty of operation, much energy need and the difficulty of production mentioned in relation with the internal drum cause all the costs and consumption of the related drying machine, principally energy and production, to be increased.

Another shortcoming and disadvantage of the carpet- or mat-drying machines within the state of the art is that the roller used for bearing and rotating the drums in said drying machines gets heated in a very short period of operation as the drums are heavy in terms of mass and difficult to be operated. The capability of the heated roller for bearing and moving, is decreased. In such a case, most of the time the relevant drying machine is stopped and waited until the rollers cool down. This causes the relevant drying machine to operate discontinuously. The efficiency and the productivity of the drying machine that is discontinuously operating decrease. This, in turn, means loss of time and work.

Another shortcoming and disadvantage of the carpet- or mat-drying machines within the state of the art is that a high volume of sound comes out from roller and bearings, as well as from the other parts while the drums inside said drying machine are rotating. The major reason for this condition is that the drums on the machine are heavy. When heavy drums are rotated at high speeds, a high volume of sound comes both from the drums, and from the roller and bearings that the drums are in connection with. This sound makes the use and operation of said drying machine disturbing to the greatest extent.

Consequently, it has become compulsory to make an improvement in the technical field because of the insufficiency of current solutions and the need for a productivity innovation eliminating the above-mentioned disadvantages, providing the drying machines used for drying carpets, mats and the like to operate more quietly, to be lighter and to be used, in accordance with the intended purpose, more efficiently and for a longer period of time, with less energy consumption by preventing its parts from getting heated.

### BRIEF SUMMARY OF THE INVENTION

The present invention, composed by taking the current conditions into consideration, aims to solve the above-mentioned disadvantages.

The object of the present invention is to provide the drying machines used for drying carpets, mats and the like to operate more quietly, to be lighter, and to be used, in accordance with the intended purpose, more efficiently and for a longer period of time with less energy consumption by preventing its parts from getting heated.

Another object of the present invention is to provide both the internal drum, and therefore the related drying machine, to be lighter thanks to the fact that the internal drum used in said drying machine is made of composite material. Therefore, the usage and operation of the internal drum is much easier and requires lower force.

A further object of the present invention is that said internal drum can be produced more easily and in a shorter period of time as the used internal drum is made of composite material. Therefore, the internal drum can be mass-produced with high productivity and at high performance.

Another object of the present invention is to provide the production and energy costs of both the internal drum and the drying machine where the internal drum is used to be much lower as the internal drum can be operated with low energy and produced more easily, in a serial manner and with high productivity.

A further object of the present invention is to eliminate the problem of heating with the help of the fan and accessories while the roller used in said drying, machine is operating. Therefore, the roller, the temperature of which is decreased, is provided, to operate with full productivity and performance.

Another object of the present invention is that said internal drum and the drying machine can be operated in a serial manner discontinuously for a long period as the rollers can operate without getting heated. Therefore, the operation productivity and the performance of said drying machine and the internal drum is maximized.

A further object of the present invention is to make the carpets and mats to be dried effectively in a short period of time and easily by maximizing the efficiency and performance of the internal drum and said drying machine. Therefore, the operation productivity provided in said drying machine is maximized, as well.

A further object of the present invention is to provide said drying machine to operate with low sound as the internal drum is coated with isolated external drum and the internal drum is made of composite material which is light in terms of mass. Therefore, the disturbing sound created while said drying machine is operating is eliminated as much as possible.

A further object of the present invention is to increase both the producer and consumer satisfaction as the parts of the drying machine can be produced easily and the machine can be operated with low energy and at high performance.

The structural and characteristic aspects, and all the advantages of the present invention will be understood more clearly by means of the following figures and the detailed description written with certain references to these figures: therefore, the evaluation should be made by taking these figures and the detailed description into consideration.

### BRIEF DESCRIPTION OF THE SEVERAL VIEWS OF THE DRAWINGS

In order for the advantages of the present invention together with its structure and additional elements to be understood in the best way, it should be evaluated together with the figures described in the following.

FIG. 1 is the demounted perspective view of the productivity-booster innovation according to the present invention and the drying machine on which the innovation is applied.

FIG. 2 is the rear perspective view of the drying machine where the productivity-booster innovation is applied according to the present invention, when it is mounted.

FIG. 3 is the front perspective view of the drying machine where the productivity-booster innovation is applied according to the present invention, when it is mounted.

FIG. 4 is the side sectional view of the drying machine where the productivity-booster innovation is applied according to the present invention, when it is mounted.

### DESCRIPTION OF THE REFERENCE NUMERALS USED IN THE FIGURES

10—Productivity-booster

20—Back flame

201—Centering diameter

202—Mourning Element

21—Front frame

22—Wheel

211—Big Gap

30—Internal drum

31—Internal Drum Shaft

40—External Drum

50—Roller

51.1—1st Protector sheet

51—2nd Protector sheet

52—Segment

53—Roller bearing

60—Fan

61—Roller cap

62—External cap

70—Flange

71—External bearing

711—Carrier cap

72—Internal drum pulley

73—Motor pulley

80—Motor

81—Connection Table

82—Connection Element

83—Preserving Cap

84—Strap

90—Drying Machine

### DETAILED DESCRIPTION OF THE INVENTION

In this detailed description, the productivity-booster (10) according to the present invention is disclosed only for a better understanding of the present invention, without posing any limiting effect.

Accordingly, the present invention relates to a productivity-booster (10) which is moved by the motor (80) embedded in the front and back frame (20, 21) by means of the internal drum (31), roller (50), external bearing (71) and flange (70), comprising an internal drum (30) made of composite material, external drum (40) coating said internal drum (30) externally and providing the machine (90) to work quietly thanks to its isolation, and a fan (60) lowering the temperature while the roller (50) of the machine (90) is operating.

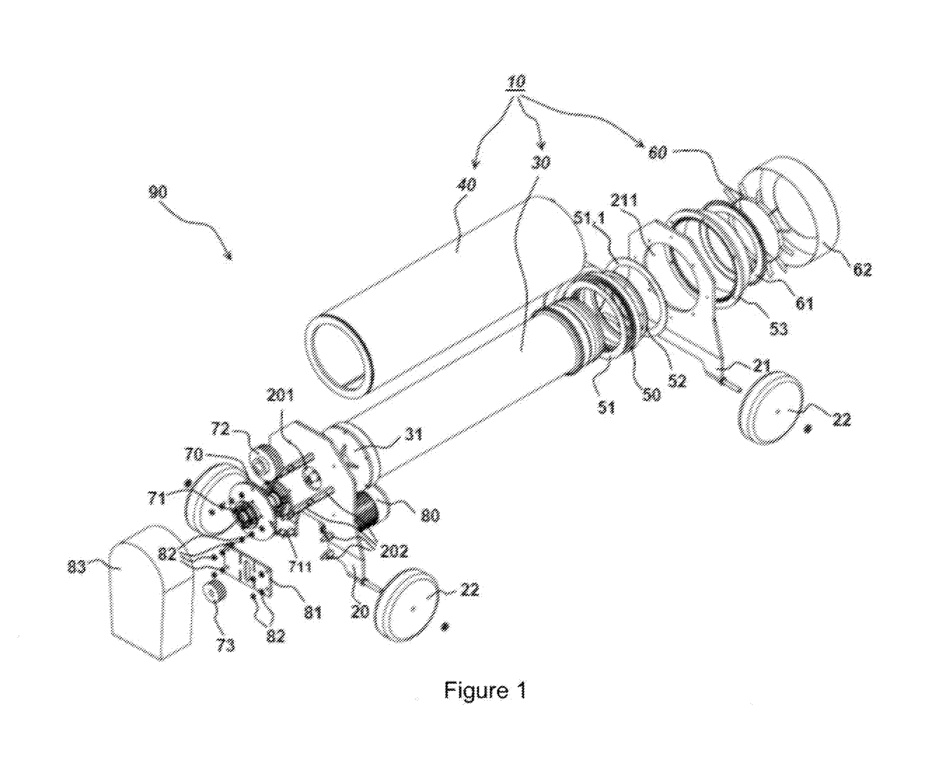

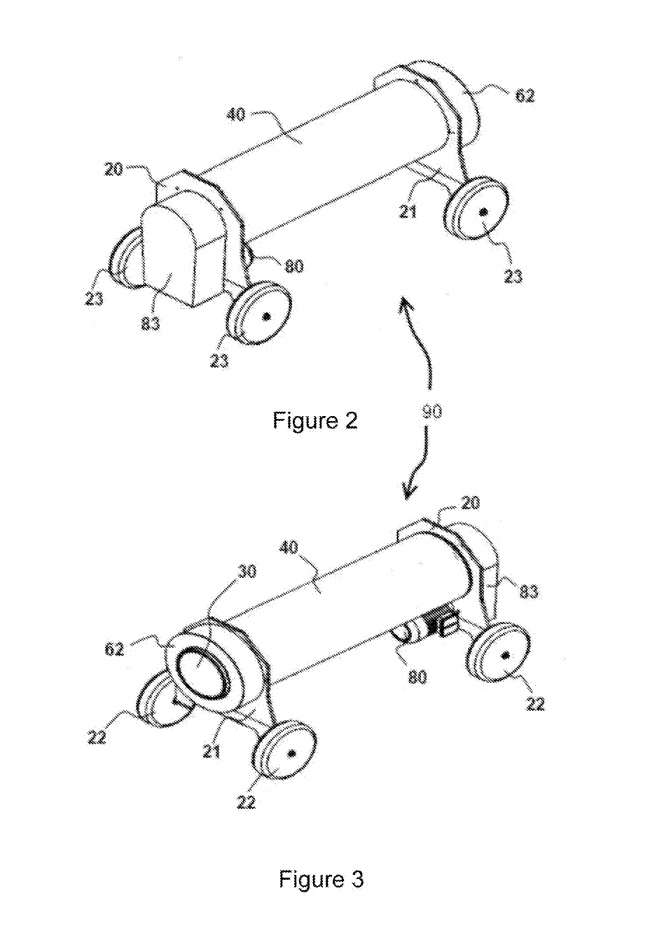

In FIGS. 1, 2 and 3, the demounted perspective, rear and front perspective views of the productivity-booster (10) and the drying machine (90) are shown, respectively. The front and hack frame (20, 21) are the parts keeping the drying machine (90) up and on which all the other parts are formed or mounted. At the edge of the bottom ends of said frames (20, 21), tour heels (22) are mounted in total, to for each. These heels (22) enable said drying machine (90) to move. On the outer surface of the back frame (20), there are eight mounting elements (202) in total so that the other parts can be mounted. A big gap (211) is created on the front frame (21). This big gap (211) is connected to the operation machine as reference while the front frame (21) is being processed with machining method, and the front frame is provided to be processed, by means of metal removing methods. On the big gap (211) available on the front frame (21), there are rabbets in which the external drum (40) and the roller bearing (53) will be fitted. The rabbets created for centering the roller (53) and the external drum (40) are reference axes.

The productivity-booster (10) according to the present invention is applied by changing, the content of the internal drum (30) and external drum (40) in said drying machine (90) and by adding the fan (60) decreasing the temperature of the roller (50) inside the machine. The internal drum (30) is located inside the external cap (62) with an open end, wherein its one end is embedded in and passes through the roller (50) inside the big gap (211) of the front frame (21). The centering diameter (201) is for centering the internal drum (30) and the external bearing (71). This drum (30) is the main part where said drying machine (90) performs the drying process. The internal drum (30) is produced with a gap inside so that the stuff like carpet or mat to be dried can be placed. Said drum (30) is made of composite material. Therefore, the internal drum (30) can be very light in terms of mass, and used that way.

It is a productivity-booster (10) development that internal drum (30) is made of composite material. As it is produced of composite material which is very light, the internal drum (30) is much easier to be operated and it requires low force. This provides the internal drum (30) to be operated at a high level of productivity with low enemy Moreover, as the internal drum (30) is made of composite material, the production of said drum (30) is made easier.

The external drum (40) coats the internal drum (30) totally. Both ends of this drum (40) are fixed onto the front and back frames (20, 21). The external drum (40) is produced in an isolated manner, and therefore it assumes the characteristic of providing isolation. It is a development of the productivity-booster (10) according to present invention that the external drum (40) is produced in an isolated manner. Thanks to the external drum (40) having an isolation characteristic, the problem of operating at a high volume of sound created either by internal drum (30), or the roller (50) and bearings (70, 71) while said drying machine (90) is operating is eliminated.

On the part of the internal drum (30) facing the from frame (21), first of all the 1st protecting: sheet (51), then roller (50), and then the security segment (52), and at last the 2nd roller sheet (51.1) are connected. On the rabbet created on the outer part of the big gap (211) available on the front frame (21), the roller bearing (53) is mounted. After the roller cap (61) is mounted, the fan (60) serving to cool down the machine is mounted, and lastly the external cap (62) is mounted.

The function of the roller (50) is to provide the internal drum (30) to perform its rotational movement by bearing its one end. During this movement, the roller (50) gets heated. In order to prevent the roller (50) from getting heated in this manner, a fan (60) has been added to the structure of the drying machine (90) as a development of the productivity-booster (10) according to the present invention. This fan (60) is mounted between the roller cap (61) which is located on the right of the segment (53) of the roller (50) according to FIG. 1 and the external cap (62.). Said caps (61, 62) preserve the fan (60) from the inside and outside, and therefore provide it to perform its function perfectly. The external cap (62) also provides protection to said drying machine (90) by closing its right part according to FIG. 1.

The function of the fan (60) is to eliminate the heating created while the roller (50) is operating. The tan (60) provides the heat created on the roller (50) with its rotational movement to be immediately discharged from that location, Therefore, the roller (50) is provided to cool down. As the heat created by the roller (50) is immediately discharged and the roller is cooled down, said drying machine (90) does not need to be stopped constantly because of the roller (50) heating. Therefore, said drying machine (90) can be operated continuously without any interruption and without causing any loss of labor.

The parts of the drying machine (90) other than the ones described above are located on the left surface or at the bottom of the back frame (20) according to FIG. 1. One of these parts is the motor (80). Said motor (80) provides the drive needed for the internal drum (30) of said drying machine (90) to be rotated. This motor (80) is located under the back frame (20). Mounting of the motor (80) to the back frame (20) is provided by the connection table (81) fixed, by means of connection elements (82), onto the mounting elements (202) located symmetrically on the outer surface of the back frame (20) bottom part.

Likewise, the motor pulley (73) is fitted to the end of the motor (80) connected to the back frame (20). This pulley (73) transmits the movement that it gets from the motor (80) to the big pulley (72) by means of moving straps (84). The internal drum pulley (72) is mounted onto the internal drum shaft (31). Its function is to provide the internal drum (30) to rotate by transmitting the movement that it receives from the motor pulley (73) to the internal drum shaft (31). Two bearings are used for bearing the internal drum shaft (31) on the back frame (20). One of these bearings is the external bearing (71) located on the centering diameter (201), and this external bearing (71) plays a role in fixing the internal drum shaft (31), as well as providing, it to be rotated. The other bearing providing the internal drum shaft (31) to be embedded on the back frame (20) is the external hearing (71). The external bearing (71), on the other hand, plays a role in rotating the internal drum shaft (31), as well as providing it to be fixed. The internal drum pulley (72), on the other hand, is located on the internal drum shaft (31), between said internal and external bearings (70, 71). The preserving cap (83) closes the left external surface of the back frame (20) according to FIG. 1. Its function is to protect all the external parts mounted on this external surface of the back frame (20) from the external forces.

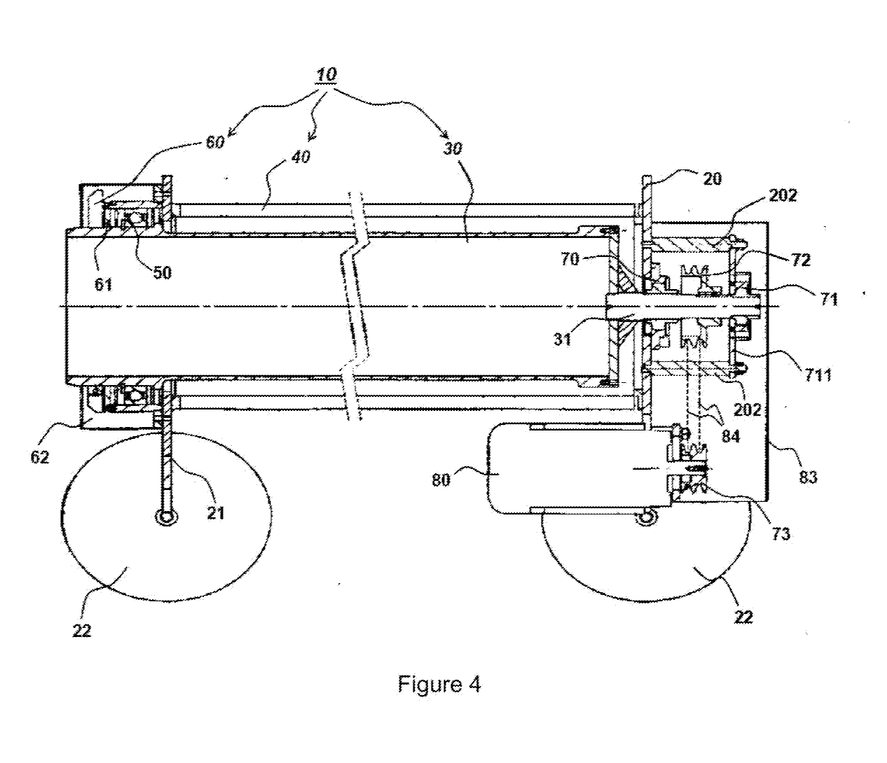

The functions of the above-mentioned parts, the productivity-booster (10) according to the present invention, the respective locations of which are described, and the working principle of the drying machine (90) on which the innovation is applied are as follows based on FIG. 4:

First of all, the stuff like carpets, mats or the like that have been washed and desired to be dried are located inside the drum (30) from the front frame part of the internal drum (30). Following the placement of said stuff, the drying machine (90) is operated, and the motor (80) is activated. The motor (80) produces rotational movement as it operates, and transfers this movement to the small pulley (73) on its end. This pulley (73) transfers the movement that it receives to the big pulley (72) by means of the straps (84) on it. The internal drum pulley (72) transfers the movement that it receives from the straps (84) to the internal drum shaft (31) on which it is fixed. The internal drum shaft (31) transmits the movement that it receives directly to the internal drum (30) with which it is connected, and provides that drum (30) to rotate. The internal drum (30) rotates around its own axis on the front and back frame (20, 21) that it is embedded thanks to the movement received from the shaft (31). By creating a centrifugal force with this rotational movement, first of all the stuff that are desired to be dried are removed from the water on them, and then all the water and the wetness on said stuff is removed.

The internal and external bearing (70, 71) to which the right, end of the internal drum (30) is embedded, and the roller (50) to which its left end is embedded have contributed greatly to the internal drum to perform its mentioned rotational movement. As it is made of composite material, the internal drum (30) can perform the rotational movement very easily. Therefore, the energy used for rotating the internal drum (30) is needed at a lower level. The external drum (40) provides isolation of the disturbing and high volume of sound that the internal drum (30) creates while it is rotating. The fan (60) provides the heat created on the roller (50) while the internal drum (30) is rotating to be discharged from that pan. Thanks to these three developments, of the productivity-booster (10) according to the present invention, both the internal drum (30) and said drying machine (90) can be used with high-productivity and performance for long periods without any interval in accordance with the intended purposes.

The productivity-booster (10) providing a solution successfully for the above-mentioned technical problems can be used in the drying machines used for drying the stuff like carpet and mat and in the relevant parts, providing it to operate with low sound, the machine to be light and to be used efficiently and for long-term with less energy consumption by preventing its parts from getting heated.

1. A drying machine comprising an internal drum, an external drum coating said internal drum all around, a back frame and a front frame that are fixed by means of internal and external bearings so that said internal drum can make rotational movement; in order to operate with light structure, low energy consumption and high-productivity, said machine comprising:
an internal drum made of a composite material.

2. A drying machine according to claim 1, comprising an external drum coating said internal drum and having an isolation characteristic.

3. A drying machine according to claim 1, comprising a fan on said front frame which is mounted between the internal and external cap and which causes the roller to cool down.
